(19) United States
(12) Patent Application Publication
(10) Pub. No.: US 2016/0061201 A1
(43) Pub. Date: Mar. 3, 2016

(54) PUMP HAVING AN ELECTRIC MOTOR

(71) Applicant: ROBERT BOSCH GMBH, Stuttgart (DE)

(72) Inventors: Josef Frank, St. Koloman (AT); Alexander Fuchs, Adnet (AT)

(21) Appl. No.: 14/780,945

(22) PCT Filed: Feb. 11, 2014
(86) PCT No.: PCT/EP2014/052623

§ 371 Date: Sep. 28, 2015

(30) Foreign Application Priority Data
Mar. 27, 2013 (DE) 102013205442.4

(51) Int. Cl. F04C 15/00; B22F 3/16; H02K 15/03; H02K 1/27; H02K 1/28; H02K 15/12; F04C 2/10; B22F 5/00

(52) U.S. Cl. CPC F04C 15/008; F04C 2/10; B22F 3/164; B22F 5/009; H02K 1/276; H02K 1/28; H02K 15/12; H02K 15/03

(57) ABSTRACT

The invention relates to a pump (5) having an electric motor (4), more particularly for a motor vehicle, for pumping a fluid, comprising an impeller (18) that has pumping elements (19) and can carry out a rotary movement about an axis of rotation (27); a working chamber around the impeller (18); an electric motor with a stator (13) and a rotor (16), the rotor (16) being provided with permanent magnets (17); and preferably a housing (8); the rotor (16) and the permanent magnets (17) being produced by sintering, and the permanent magnets (17) on the rotor (16) being integrally bonded to the rotor (16) by sintering.

### BACKGROUND OF THE INVENTION

The present invention relates to a pump with electric motor, a method for producing a rotor with permanent magnets, and a method for producing a pump with electric motor.

Pumps with electric motor are used for a wide variety of technical applications for the purposes of delivering a fluid. For example, fuel pumps serve for delivering fuel to an internal combustion engine. The electric motor of the pump comprises a stator and a rotor with permanent magnets. In the case of an electric motor with a permanent magnet-excited rotor, permanent magnets are installed or integrated into the rotor.

The rotor and also the permanent magnets are in this case produced in a separate sintering process. For this purpose, firstly, a green product for the rotor is pressed from a sintering material by way of a molding and pressing tool, and, subsequently, said green product is sintered in a sintering furnace and subjected to reworking after the sintering process. The green products for the permanent magnets are pressed from a different sintering material by way of a molding and pressing tool, and are subsequently sintered in a sintering furnace. In this case, the sintering of the green products for the permanent magnets is performed separately from the sintering of the green product of the rotor. After the sintering of the green products of the permanent magnets, said green products are subjected to reworking. For the arrangement or integration of the sintered permanent magnets, the latter are introduced into recesses on the sintered rotor and are fastened to the rotor by way of adhesive. This disadvantageously necessitates cumbersome cohesive fastening of the sintered permanent magnets to the recesses of the rotor by way of adhesive.

DE 299 13 367 U1 presents an internal-gear pump having at least one internally toothed internal gear and having an externally toothed impeller, with or without sickle, which meshes with said internal gear, and having an electric drive, which is formed by virtue of the internal gear forming the inner side of a rotor of a brushless electric motor and a stator being arranged adjacent to the rotor, wherein the rotor, which comprises the internal gear, is held rotatably at the outer side by a bearing or a plain bearing, wherein the stator is shielded and sealed off with respect to the rotor and with respect to the interior of the pump such that the bearing or plain bearing situated between the stator and rotor is impermeable to liquid and is sealingly connected, at its two face sides, to in each case one closure cover.

### SUMMARY OF THE INVENTION

The invention provides a pump with electric motor, in particular for a motor vehicle, for delivering a fluid, comprising an impeller having delivery elements, which impeller can perform a rotary movement about an axis of rotation, a working chamber provided at the impeller, an electric motor with a stator and a rotor, wherein the rotor is equipped with permanent magnets, preferably a housing, wherein the rotor and the permanent magnets are produced by sintering, wherein the permanent magnets are connected to the rotor by way of a cohesive sintered connection to the rotor. The permanent magnets are connected to the rotor by way of a cohesive sintered connection. The cohesive sintered connection is produced in a common sintering process both of the green product for the rotor and of the green products for the permanent magnets, and it is thus advantageously possible for the cumbersome adhesive connection between the permanent magnets and the rotor to be dispensed with. The production of the pump with electric motor is thereby made much cheaper and easier.

The impeller with the delivery elements and the electric motor are expediently arranged within the housing.

In particular, the permanent magnets are arranged in recesses, in particular in blind holes or in through holes, of the rotor, and/or the permanent magnets are connected to the rotor by way of a positively locking connection to the rotor, in particular owing to a corresponding geometry of the recesses and/or geometry of the permanent magnets. In the case of an arrangement of the permanent magnets in the recesses of the rotor, said permanent magnets can be fastened particularly easily to the rotor. Furthermore, the arrangement in the recesses also ensures positively locking fastening of the permanent magnets in the rotor. Furthermore, the recesses have a corresponding geometry, and the permanent magnets have a correspondingly complementarily shaped geometry, such that, in this way, an additional positively locking connection exists between the permanent magnet and the rotor, in particular for example by virtue of the fact that additional grooves are arranged at the recesses, within which grooves a projection of the permanent magnets is arranged.

In a further refinement, the pump is integrated into the electric motor or vice versa by virtue of the rotor being formed by the impeller, and/or the permanent magnets are connected to the rotor by way of a non-positively locking connection to the rotor. The permanent magnets and the rotor are composed of a different sintering material, such that, in this way, a different change in shape occurs during the sintering process, and thus the permanent magnets on the rotor, in particular on the recesses of the rotor, are connected to the rotor under a preload and thus in non-positively locking fashion.

In a supplementary embodiment, the rotor with the permanent magnets is produced by way of a method as described in this property right application, and/or the pump is in the form of an internal-gear pump, and/or the electric motor is electronically commutated.

The invention also provides a method for producing a rotor with permanent magnets for an electric motor, having the steps: molding, in particular pressing or casting, a green product for the rotor from a sintering material, in particular from a sintering powder or a sintering granulate, molding, in particular pressing or casting, green products for the permanent magnets from a sintering material, in particular from a sintering powder or a sintering granulate, sintering the green product of the rotor to form the rotor in a sintering process, sintering the green products for the permanent magnets to form the permanent magnets in a sintering process, connecting the permanent magnets to the rotor, wherein the green product for the rotor and the green products for the permanent magnets are sintered together simultaneously in a common sintering process and are thereby connected to one another, in particular by way of a cohesive sintered connection. The green product for the rotor and the green products for the permanent magnets are sintered simultaneously in a common sintering process, such that, in this way, during the sintering process, the green products of the permanent magnets are connected to the green products of the rotor, in particular by way of the cohesive sintered connection. During the sintering process, the green products of the permanent magnets and the green product of the rotor are heated, in particular to a temperature below the melting temperature, and, here, a reduction in the volume of the green products occurs as a change in shape, with a resulting compaction and surface diffusion between the particles of the sintering materials, such that, in this way, during the sintering process, the green products of the permanent magnets are connected to the green product of the rotor.

It is preferably the case that the green product for the rotor is molded and pressed from a first sintering material, in particular from a first sintering powder or a first sintering granulate, and the green products for the permanent magnets are molded and pressed from a second sintering material, in particular from a second sintering powder or a second sintering granulate, and the first and second sintering materials are composed of a different material, and/or the green products of the permanent magnets are connected in non-positively locking fashion to the green product of the rotor during the sintering process, and/or the green product for the rotor and the green products for the permanent magnets are sintered in an identical sintering furnace, in particular vacuum furnace. The first and second sintering materials differ, as a different material is required for the rotor than for the permanent magnets. If the first and second sintering materials exhibit a different reduction in volume as a change in shape during the sintering process, and if the reduction in volume of the rotor is less than the reduction in volume of the permanent magnets or of the green products of the permanent magnets, a preload is generated between the green products of the permanent magnets, or the permanent magnets, and the green product of the rotor, or the rotor, such that the permanent magnets are thereby connected in non-positively locking fashion to the rotor.

In one variant, the second sintering material is introduced into recesses, in particular into blind holes or through holes, of the green product of the rotor, and, subsequently, the second sintering powder within the recesses of the green product of the rotor is molded and pressed, by way of a second molding and pressing tool, to form the green products for the permanent magnets.

It is expediently provided that the green product for the rotor is molded and pressed by means of a first molding and pressing tool, and the green products for the permanent magnets are molded and pressed by means of the second molding and pressing tool, and, preferably, the first and second molding and pressing tools differ.

In a further embodiment, firstly, the green product for the rotor is molded, in particular pressed, and, secondly, the green products for the permanent magnets are molded, in particular pressed, and/or the green products of the permanent magnets, or the permanent magnets, are connected in positively locking fashion to the green product of the rotor, or to the rotor, owing to a corresponding geometry of the recesses of the green product of the rotor. Here, the molding and pressing tool for the molding and pressing of the green product of the rotor has a geometry which is such that, at the recesses of the rotor, auxiliary geometries are formed, for example a groove or a bore, such that, subsequently, during the introduction of the second sintering material into the recess after the pressing of the green product of the rotor, the second sintering material for the permanent magnets also fills said auxiliary geometries, and thus an additional positively locking connection between the green product of the rotor, or the rotor, and the green products of the permanent magnets, or the permanent magnets, is produced. The arrangement of the permanent magnets in the recesses also results in a positively locking connection between the permanent magnets and the rotor.

In particular, the first sintering material, in particular the first sintering powder or the first sintering granulate, is supplied in automated fashion to the molding and pressing tool, in particular to the first molding and pressing tool, for the rotor, and/or the second sintering material, in particular the second sintering powder or the second sintering granulate, is supplied in automated fashion to the molding and pressing tool, in particular to the second molding and pressing tool, for the permanent magnets.

In a further refinement, the permanent magnets are magnetized after the sintering process, in particular within the recesses of the rotor. After the sintering process, and preferably further method steps, the permanent magnets are magnetized. This is possible because the permanent magnets are formed from a corresponding material.

In a supplementary variant, the rotor with the permanent magnets is, after the common sintering process, processed by way of at least one further method, in particular sandblasting and/or grinding and/or polishing and/or deburring and/or cleaning and/or clamping and/or packaging.

The invention also provides a method for producing a pump with electric motor, in particular a pump with electric motor as described in this property right application, for delivering a fluid, having the steps: providing an impeller, which has delivery elements, for the pump, providing a housing, providing an electric motor, which has a stator and a rotor, for driving the pump, wherein the rotor is equipped with permanent magnets, and the rotor and the permanent magnets are produced by sintering, arranging and assembling the impeller with delivery elements and the electric motor with the housing, in particular within the housing, to form the pump with electric motor, wherein the rotor with the permanent magnets is produced by way of a method as described in this property right application.

In a further variant, the impeller and the rotor are produced such that the impeller with the delivery elements also forms the rotor, and/or an electronically commutated electric motor is provided.

In a further refinement, the pump is provided as an internal-gear pump with an inner gearwheel and an outer gearwheel, and, in particular, the outer gearwheel is produced such that the outer gearwheel forms the impeller with teeth as delivery elements and the rotor with the permanent magnets.

In a further embodiment, the rotor, and/or the first sintering material for the rotor, are/is composed at least partially, in particular entirely, of steel, in particular sintering steel, or of magnetically soft iron.

In a supplementary refinement, the permanent magnets, and/or the second sintering material for the permanent magnets, are/is composed at least partially, in particular entirely, of a mixture of neodymium (Nd), iron (Fe) and boron (B) or of a mixture of samarium (Sm), cobalt (Co) and iron (Fe).

In a further refinement, the delivery elements are blades or teeth of a gearwheel.

In a supplementary variant, the pump is a gearwheel pump, in particular an internal-gear pump.

In a further refinement, the impeller forms the rotor, and/or the permanent magnets are arranged or integrated on or in the impeller, that is to say, preferably, the pump is integrated into the electric motor or vice versa.

In a further embodiment, the pump is integrated into the electric motor or vice versa; preferably, the pump and the electric motor constitute non-separable structural units.

In a further variant, the pump with electric motor comprises an inlet opening and an outlet opening for the fluid, which openings issue into the working chamber.

In a further refinement, the pump is an external-gear pump or a centrifugal pump or a vane-type pump.

The pump with preferably integrated electric motor expediently comprises a preferably electronic control unit for controlling the energization of the electric magnets.

The housing of the predelivery pump and/or the housing of the high-pressure pump and/or the inner gearwheel and/or outer gearwheel are/is expediently composed at least partially, in particular entirely, of metal, for example steel or aluminum.

In particular, the delivery rate of the electric predelivery pump is controllable and/or regulable.

### BRIEF DESCRIPTION OF THE DRAWINGS

Below, exemplary embodiments of the invention will be described in more detail with reference to the appended drawings, in which:

FIG. 1 shows a highly schematized view of a high-pressure injection system,

FIG. 2 shows a perspective view of a predelivery pump without housing and of a stator,

FIG. 3 is an exploded illustration of the predelivery pump as per FIG. 2,

FIG. 4 shows a plan view of a green product of the rotor before a sintering process, in a first exemplary embodiment,

FIG. 5 shows a plan view of the green product of the rotor with the green products of the permanent magnets before the sintering process, in a second exemplary embodiment,

FIG. 6 shows a section A-A, as per FIG. 4, of the green product of the rotor,

FIG. 7 shows a section B-B, as per FIG. 5, of the green product of the rotor with a green product of a permanent magnet, and

FIG. 8 shows a flow diagram of a method for producing a rotor with permanent magnets.

### DETAILED DESCRIPTION

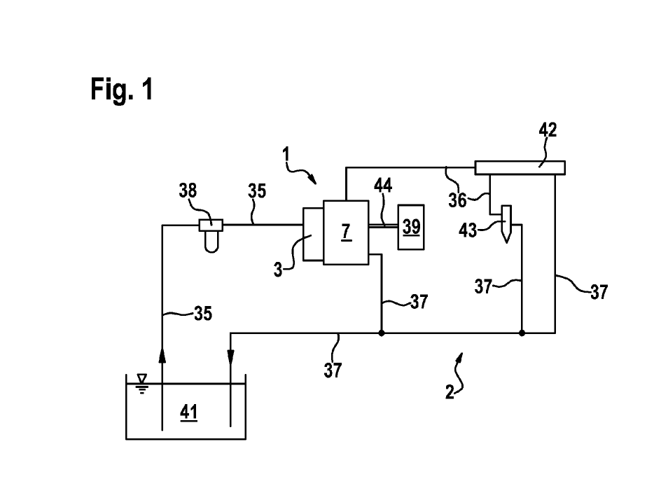

FIG. 1 illustrates a pump arrangement 1 of a high-pressure injection system 2. An electric predelivery pump 3 delivers fuel out of a fuel tank 41 through a fuel line 35. Subsequently, the fuel is delivered by the electric predelivery pump 3 to a high-pressure pump 7. The high-pressure pump 7 is driven by an internal combustion engine 39 by means of a drive shaft 44.

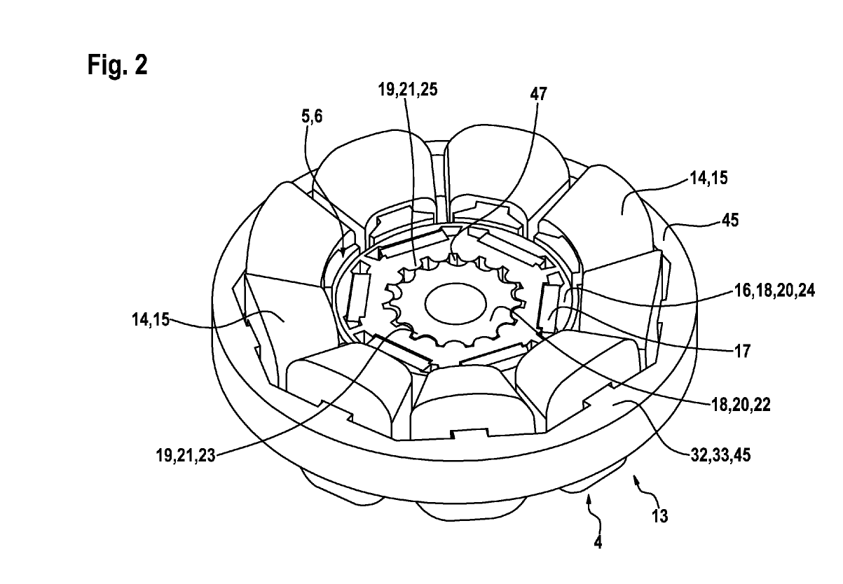

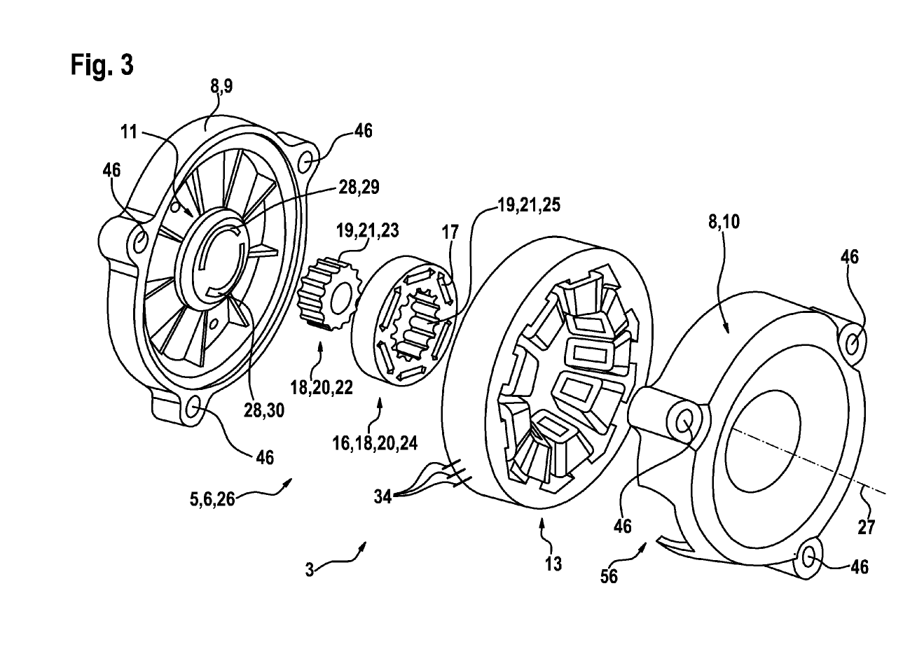

The electric predelivery pump 3 has an electric motor 4 and a pump 5 (FIGS. 2 and 3). Here, the electric motor 4 of the pump 5 is integrated into the pump 5, and, furthermore, the electric predelivery pump 3 is arranged directly on the high-pressure pump 7. The high-pressure pump 7 delivers fuel at high pressure, for example a pressure of 1000, 3000 or 4000 bar, through a high-pressure fuel line 36 to a high-pressure rail 42. From the high-pressure rail 42, the fuel is supplied at high pressure to a combustion chamber (not illustrated) of the internal combustion engine 39 by an injector 43. The fuel not required for the combustion is returned to the fuel tank 41 again via a fuel return line 37. The porting openings 28 (FIG. 2) of the electric predelivery pump 3 are connected, without an external connection, to the high-pressure pump 7. Here, the mounting position of the electric predelivery pump 3 on the high-pressure pump 7 is selected such that the fuel can be conducted from the pressure side of the predelivery pump 3 to the suction side of the high-pressure pump 7 through short hydraulic connections. A fuel filter 38 is installed in the fuel line 35 from the fuel tank 41 to the electric predelivery pump 3. In this way, it is advantageously possible for the fuel line 35 from the fuel tank 41 to the electric predelivery pump 3 to be of inexpensive design, as it does not need to withstand positive pressure. The electric motor 4 (FIGS. 2 and 3) of the electric predelivery pump 3 is operated with three-phase current or alternating current and is controllable and/or regulable in terms of power. The three-phase current or alternating current for the electric motor 4 is provided by power electronics (not illustrated) from a direct-current voltage network of an on-board electrical system of a motor vehicle. The electric predelivery pump 3 is thus an electronically commutated predelivery pump 3.

The electric predelivery pump 3 has a housing 8 with a housing pot 10 and a housing cover 9 (FIG. 3). The pump 5, in the form of an internal-gear pump 6 or gearwheel pump 26, and the electric motor 4 are arranged within the housing 8 of the predelivery pump 3. The housing pot 10 is equipped with a recess 56. The electric motor 4 has a stator 13 with windings 14 as electromagnets 15, and has a soft iron core 45 as a magnetically soft core 32, which is in the form of a laminated core 33. Positioned within the stator 13 is the pump 5, which is in the form of an internal-gear pump 6 with an inner gearwheel 22 with an inner toothed ring 23 and an outer gearwheel 24 with an outer toothed ring 25. The inner and outer gearwheels 22, 24 thus constitute a gearwheel 20 and an impeller 18, and the inner and outer toothed rings 23, 25 have teeth 21 as delivery elements 19. A working chamber 47 is formed between the inner and outer gearwheels 22, 24. Into the outer gearwheel 24 there are installed permanent magnets 17, such that the outer gearwheel 24 also forms a rotor 16 of the electric motor 4. The electric motor 4 is thus integrated into the pump 5, or vice versa. The electromagnets 15 of the stator 13 are energized in alternating fashion, such that, owing to the magnetic field generated at the electromagnets 15, the rotor 16 or the outer gearwheel 24 is set in rotational motion about an axis of rotation 27. On the stator 13 there are arranged electrical contact elements 34 which serve for the energization of the electromagnets 15. The contact elements 34 are, after the assembly process, arranged in the recess 56 of the housing pot 10.

The housing cover 9 serves as a bearing 11 or axial bearing 11 or plain bearing 11 for the inner and outer gearwheels 22, 24. Furthermore, in the housing cover 9, there are formed a suction porting opening 29 and a pressure porting opening 30, which are each in the form of porting openings 28. The fluid to be delivered, specifically fuel, flows through the suction porting opening 29 into the predelivery pump 3, and the fuel flows out of the predelivery pump 3 again from the pressure porting opening 30. Furthermore, the housing pot 10 and the housing cover 9 each have three bores 46 in which there are positioned screws (not illustrated) for screwing the housing pot 10 and the housing cover 9 together.

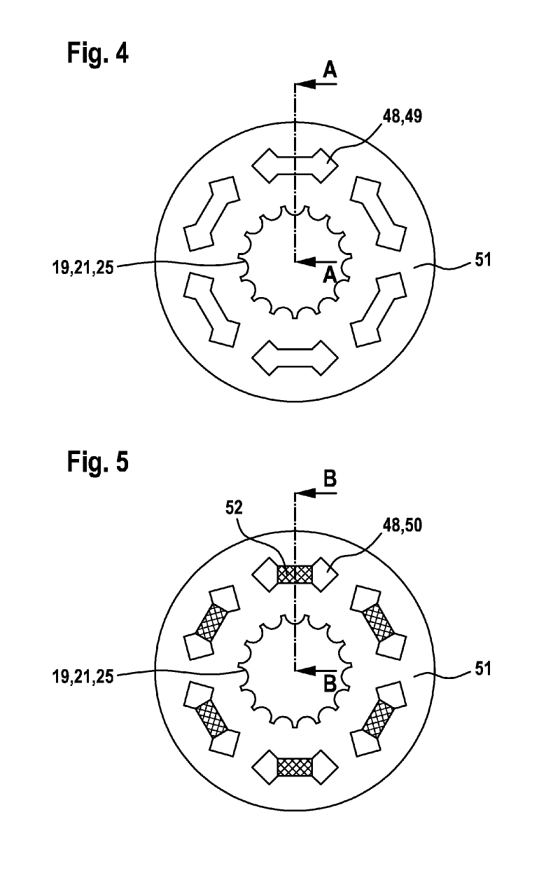

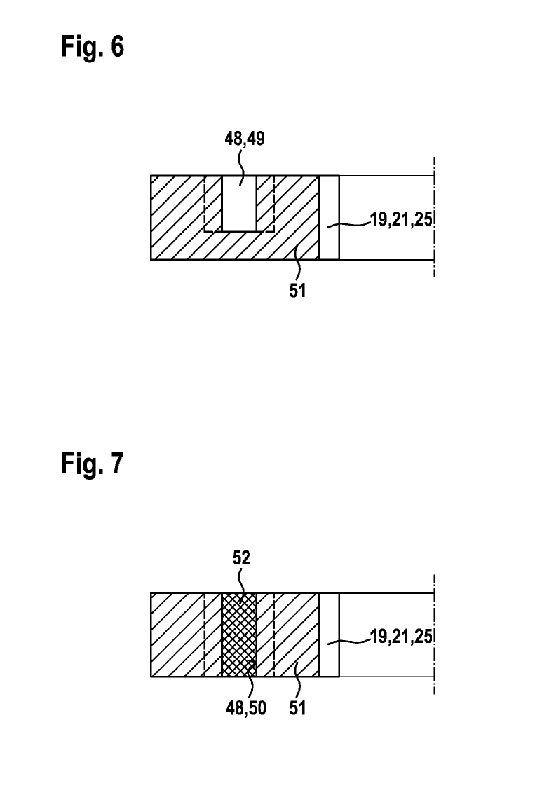

A green product 51 for the rotor 16 and the green products 52 for the permanent magnets 17 are produced by sintering. FIGS. 4 and 6 illustrate a first exemplary embodiment of the green product 51 for the rotor 16. The green product 51 for the rotor 16 is pressed or molded from a first sintering material, for example a sintering powder, by way of a first molding and pressing tool 58. Here, the green product 51 has six recesses 48 in the form of blind holes 49. After the pressing of the green product 51 for the rotor 16, a second sintering material, for example a sintering powder, is introduced into the six recesses 48 in the form of blind holes 49, and the second sintering material in the six blind holes 49 is pressed by way of a second molding and pressing tool 59. During the pressing process, additional compaction of the second sintering material is performed. Here, the first molding and pressing tool 58 has a corresponding geometry, such that the green product 51 of the rotor 16 is formed with the six recesses 48 as blind holes 49 and with the outer toothed ring 25 with teeth 21. As permanent magnets 17, use may be made either of sintered permanent magnets 17 without magnetic characteristics or of magnetic permanent magnets 17 after the magnetization by way of a magnetic field.

FIGS. 5 and 7 illustrate a second exemplary embodiment of the green product 51 for the rotor 16. Substantially only the differences in relation to the first exemplary embodiment as per FIGS. 4 and 6 will be described below. The recesses 48 are formed not as blind holes 49 but as through holes 50. In FIGS. 5 and 7, the second sintering material has already been introduced into the through holes 50, and the second sintering material in the through holes 50 has subsequently been compacted and compressed by means of the second molding and pressing tool 59.

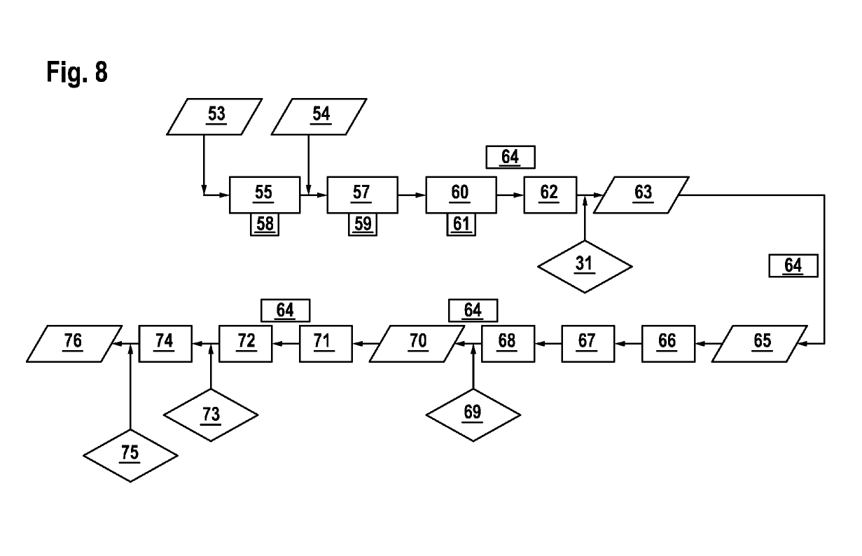

FIG. 8 illustrates a flow diagram for the production of the rotor 16. Firstly, the first sintering material is supplied 53 to the first molding and pressing tool 58. Here, the first sintering material is composed for example of sintering steel. After the pressing of the first sintering material in the first molding and pressing tool 58 to form the green product 51 of the rotor 16 with the recesses 48, the second sintering material, composed of neodymium (Nd), iron (Fe) and boron (B) is supplied 54. Here, the second sintering material is introduced into the recesses 48 of the green product 51 of the rotor 16, and, subsequently, the green products 52 of the permanent magnets 17 within the recesses 48 are pressed 57 by way of the second molding and pressing tool 59. Subsequently, the green product 51 of the rotor 16 is, together with the already-pressed green products 52 of the permanent magnets 17 within the recesses 48, placed into a vacuum furnace 61 as a sintering furnace, and, subsequently, sintering 60 or a sintering process 60 is performed here, such that the green product 51 of the rotor 16 and the green product 52 of the permanent magnets 17 are sintered and heated jointly and simultaneously in the vacuum furnace 61. After the removal of the sintered rotor 16 with the sintered permanent magnets 17 and the cooling process, transportation 64 and subsequent reworking by sandblasting 62 are thereupon performed. After further transportation 64, placement 65 into a clamping cavity is performed. Furthermore, a material inspection 31 is performed between the sandblasting 62 and packaging 63 processes. After the placement 65 into the clamping cavity (not illustrated), clamping 66 is performed, followed by reworking by grinding 67 of the two flat surfaces of the rotor 16. This is followed by polishing 68 and placement 70 into a deburring apparatus (not illustrated). Between the polishing 68 and the placement 70 into the deburring apparatus, a sampling inspection 69 of the external dimensions of the rotor 16 is additionally performed. This is followed by a deburring process 71 and a cleaning process 72. Further transportation 64 is performed between the deburring process 71 and the cleaning process 72. After the cleaning process 72, magnetization 74 of the permanent magnets 17 or of the sintered permanent magnets 17 is performed, which after the sintering process do not yet have magnetic characteristics or a magnetic field. Between the cleaning process 72 and the magnetization 74, a visual inspection 73 is performed. After the magnetization of the sintered permanent magnets 17 to form the permanent magnets 17, an inspection 75 of the magnetic field of the magnetic permanent magnets 17 is performed. At the end of the production process, the rotors 16 with the permanent magnets 17 are supplied to the method step of packaging 63.

Viewed overall, the method according to the invention for producing the rotor 16 with the permanent magnets 17 is associated with major advantages. The green product 51 of the rotor 16 without the permanent magnets 17, or without the green products 52 of the permanent magnets 17, is pressed separately from the green products 52 for the permanent magnets 17, and, subsequently, the green product 51 for the rotor 16 and the green products 52 for the permanent magnets 17 are sintered jointly and simultaneously in the vacuum furnace 61, such that, in this way, the green products 52 for the permanent magnets 17 are cohesively connected, by way of a sintered connection, to the green product 51 for the rotor 16. In this way, it is advantageously the case that only one sintering process is required to produce the rotor 16 with the permanent magnets 17, and an additional and cumbersome adhesive connection between the sintered permanent magnets 17 and the sintered rotor 16 using an adhesive is no longer required. In this way, it is advantageously possible for the costs for the production of the rotor 16 with the permanent magnets 17 to be considerably reduced, and a particularly reliable and permanent cohesive sintered connection between the permanent magnets 17 and the rotor 16 can be produced.

1. A pump (5) with electric motor (4), for delivering a fluid, comprising
an impeller (18) having delivery elements (19), which impeller is rotatable about an axis of rotation (27),
a working chamber (47) provided at the impeller (18),
an electric motor (4) with a stator (13) and a rotor (16), wherein the rotor (16) is equipped with permanent magnets (17), and
a housing (8), wherein
the rotor (16) and the permanent magnets (17) are produced by sintering, and the permanent magnets (17) are connected to the rotor (16) by a cohesive sintered connection to the rotor (16).

2. The pump with electric motor as claimed in claim 1,
characterized in that
the permanent magnets (17) are arranged in recesses (48) of the rotor (16).

3. The pump with electric motor as claimed in claim 1,
characterized in that
the pump (5) is integrated into the electric motor (4) by virtue of the rotor (16) being formed by the impeller (18).

4. The pump with electric motor as claimed in claim 1,
characterized in that
the pump (5) is in the form of an internal-gear pump (6).

5. A method for producing a rotor (16) with permanent magnets (17) for an electric motor (4), having the steps:
molding a green product (51) for the rotor (16) from a sintering material,
molding green products (52) for the permanent magnets (17) from a sintering material,
sintering the green product (51) of the rotor (16) to form the rotor (16) in a sintering process,
sintering the green products (52) for the permanent magnets (17) to form the permanent magnets (17) in a sintering process, and
connecting the permanent magnets (17) to the rotor (16),
characterized in that
the green product (51) for the rotor (16) and the green products (52) for the permanent magnets (17) are sintered together simultaneously in a common sintering process and are thereby connected to one another.

6. The method as claimed in claim 5,
characterized in that
the green product (51) for the rotor (16) is molded and pressed from a first sintering material, and the green products (52) for the permanent magnets (17) are molded and pressed from a second sintering material, and the first and second sintering materials are composed of a different material.

7. The method as claimed in claim 6,
characterized in that
the second sintering material is introduced into recesses (48) of the green product (51) of the rotor (16), and, subsequently, the second sintering powder within the recesses (48) of the green product (51) of the rotor (16) is molded and pressed, by way of a second molding and pressing tool (59), to form the green products (52) for the permanent magnets (17).

8. The method as claimed in claim 5,
characterized in that
the green product (51) for the rotor (16) is molded and pressed by means of a first molding and pressing tool (58), and the green products (52) for the permanent magnets (17) are molded and pressed by means of the second molding and pressing tool (59).

9. The method as claimed in claim 5,
characterized in that,
firstly, the green product (51) for the rotor (16) is molded, and, secondly, the green products (52) for the permanent magnets (17) are molded.

10. The method as claimed in claim 5,
characterized in that
the first sintering material is supplied in automated fashion to the molding and pressing tool (58) for the rotor (16).

11. The method as claimed in claim 5,
characterized in that
the permanent magnets (17) are magnetized after the sintering process.

12. The method as claimed in claim 5,
characterized in that
the rotor (16) with the permanent magnets (17) is, after the common sintering process, processed by way of at least one further method, including sandblasting and/or grinding and/or polishing and/or deburring and/or cleaning and/or clamping and/or packaging.

13. A method for producing a pump (4) with electric motor (5) for delivering a fluid, having the steps:
providing an impeller (18), which has delivery elements (19), for the pump (5),
providing a housing (8),
providing an electric motor (4), which has a stator (13) and a rotor (16), for driving the pump (5), wherein the rotor (16) is equipped with permanent magnets (17), and the rotor (16) and the permanent magnets (17) are produced by sintering,
arranging and assembling the impeller (18) with delivery elements (19) and the electric motor (4) with the housing, in particular within the housing (8), to form the pump (5) with electric motor (4),
characterized in that
the rotor (16) with the permanent magnets (17) is produced by way of a method as claimed in claim 5.

14. The method as claimed in claim 13,
characterized in that
the impeller (18) and the rotor (16) are produced such that the impeller (18) with the delivery elements (19) also forms the rotor (16).

15. The method as claimed in claim 13,
characterized in that
the pump (5) is provided as an internal-gear pump (6) with an inner gearwheel (22) and an outer gearwheel (24), and the outer gearwheel (24) is produced such that the outer gearwheel (24) forms the impeller (18) with teeth (21) as delivery elements (19) and the rotor (16) with the permanent magnets (17).

16. The pump with electric motor as claimed in claim 1,
characterized in that the permanent magnets (17) are connected to the rotor (16) by way of a positively locking connection to the rotor (16).

17. The pump with electric motor as claimed in claim 1,
characterized in that the permanent magnets (17) are connected to the rotor (16) by way of a non-positively locking connection to the rotor (16).

18. The pump with electric motor as claimed in claim 1, characterized in that the electric motor (4) is electronically commutated.

19. The method as claimed in claim 5,
characterized in that the green products (52) of the permanent magnets (17) are connected in non-positively locking fashion to the green product (51) of the rotor (16) during the sintering process

20. The method as claimed in claim 5,
characterized in that the green product (51) for the rotor (16) and the green products (52) for the permanent magnets (17) are sintered in an identical sintering furnace, in particular vacuum furnace.

21. The method as claimed in claim 5,
characterized in that the green products (52) of the permanent magnets (17), or the permanent magnets (17), are connected in positively locking fashion to the green product (51) of the rotor (16), or to the rotor (16), owing to a corresponding geometry of the recesses (48) of the green product (51) of the rotor (16).

22. The method as claimed in claim 5,
characterized in that the second sintering material is supplied in automated fashion to the molding and pressing tool (59).

23. The method as claimed in claim 13,
characterized in that an electronically commutated electric motor (4) is provided.
